(19) United States
(12) Patent Application Publication
(10) Pub. No.: US 2007/0254215 A1
(43) Pub. Date: Nov. 1, 2007

(54) Non-Aqueous Electrolyte and Secondary Battery Containing the Same

(76) Inventors: Takaharu Morikawa, Osaka (JP); Takafumi Oura, Osaka (JP); Atsushi Otsuka, Osaka (JP); Shinichi Kinoshita, Chiba (JP); Minoru Kotato, Ibaraki (JP)

Correspondence Address: MCDERMOTT WILL & EMERY LLP, 600 13TH STREET, NW, WASHINGTON, DC, 20005-3096, US

(21) Appl. No.: 11/661,682

(22) PCT Filed: Aug. 29, 2005
(86) PCT No.: PCT/JP05/15650

§ 371 Date: Mar. 2, 2007

(30) Foreign Application Priority Data
Sep. 3, 2004 (JP) 2004-256626

(51) Int. Cl. H01M 6/16

(52) U.S. Cl. 429/324

(57) ABSTRACT

Disclosed is a non-aqueous electrolyte containing a non-aqueous solvent, a solute dissolved in the non-aqueous solvent, and a hydrogenated terphenyl. The solute comprises an alkali salt containing boron and an alkali salt containing no boron. An amount of the hydrogenated terphenyl contained in the non-aqueous electrolyte is preferably 0.5 mass % to 3.5 mass %. For example, LiBF₄, NaBF₄ or KBF₄ is used as the alkali salt containing boron, while LiPF₆, LiClO₄, LiAsF₆, LiCF₃SO₃, LiN(SO₂CF₃)₂, LiN(SO₂C₂F₅)₂ or LiC(SO₂CF₃)₃ is used as the alkali salt containing no boron.

### TECHNICAL FIELD

The present invention relates to a non-aqueous electrolyte excellent in reliability and a secondary battery containing the same. Specifically, the present invention relates to a non-aqueous electrolyte that provides a non-aqueous electrolyte secondary battery excellent in cycle life characteristics and also excellent in safety during overcharge.

### BACKGROUND ART

As overcharge of a non-aqueous electrolyte secondary battery proceeds, an excessive amount of lithium is released from a positive electrode, causing degradation in thermal stability of the positive electrode. A negative electrode absorbs the lithium released from the positive electrode. However, when the positive electrode releases the lithium excessively, the lithium deposits on the surface of the negative electrode. In this case, thermal stability of the negative electrode as well as the positive electrode is remarkably degraded. Eventually, the battery generates heat, and the safety is degraded.

With respect to the above-mentioned problem, one proposal is that a small amount of biphenyl, which is one of aromatic compounds, be added to the non-aqueous electrolyte in the battery (Refer to Patent Document 1). Biphenyl is polymerized in the battery in an overcharged state. As a result, a separator clogs, the internal resistance of the battery is increased and the safety of the battery is improved.

Another proposal is that a small amount of terphenyl and terphenyl having an alkyl group be added to the non-aqueous electrolyte. In this case also, because of the similar effect, the safety of the battery in an overcharged state is improved (Refer to Patent Document 2).

However, biphenyl and terphenyl are solid and have low solubility to a non-aqueous solvent. Accordingly, when at low temperatures, part of biphenyl or terphenyl deposits, and the battery characteristics may be degraded.

Moreover, because of their relatively low oxidative polymerization potentials, biphenyl and terphenyl are polymerized during storage at high temperatures or during charge/discharge cycles. Accordingly, the electrical characteristics of the battery may be degraded.

Furthermore, biphenyl and terphenyl generate hydrogen during polymerization. Accordingly, there may be a possibility that the internal pressure of the battery rises greatly, and leakage occurs in normal use of the battery. Patent Document 1: Japanese Patent Publication No. 3061756 (Japanese Laid-Open Patent Publication Hei 9-106835) Patent Document 2: Japanese Laid-Open Patent Publication 2000

### DISCLOSURE OF THE INVENTION

### PROBLEM TO BE SOLVED BY THE INVENTION

The present invention intends to provide a highly reliable non-aqueous electrolyte secondary battery excellent in charge/discharge cycle characteristics or high-temperature storage characteristics, and excellent in safety during overcharge.

### MEANS FOR SOLVING THE PROBLEM

The present invention relates to a non-aqueous electrolyte comprising (a) a non-aqueous solvent, (b) a solute dissolved in the non-aqueous solvent, and (c) a hydrogenated terphenyl, the solute (b) comprising an alkali salt containing boron and an alkali salt containing no boron.

Herein, it is preferable that an amount of the hydrogenated terphenyl (c) contained in the non-aqueous electrolyte is 0.5 mass % to 3.5 mass %, and more preferable that it is 1.0 mass % to 1.5 mass %.

It is preferable that for the alkali salt containing boron, at least one selected from the group consisting of LiBF₄, NaBF₄ and KBF₄ is used. It is preferable that an amount of the alkali salt containing boron contained in the non-aqueous electrolyte is 0.1 mass % to 0.5 mass %, and more preferable that it is 0.15 mass % to 0.35 mass %.

It is preferable that for the alkali salt containing no boron, at least one selected from the group consisting of LiPF₆, LiClO₄, LiAsF₆, LiCF₃SO₃, LiN(SO₂CF₃)₂, LiN(SO₂C₂F₅)₂ and LiC(SO₂CF₃)₃ is used. It is preferable that the alkali salt containing no boron is contained in the non-aqueous electrolyte at a concentration of 0.5 M to 3 M.

It is preferable that the non-aqueous electrolyte of the present invention further comprises diphenyl ether (DPE) in an amount of 0.1 mass % to 1 mass %.

It is preferable that the non-aqueous solvent (a) includes a cyclic carbonate having no C═C unsaturated bond (unsaturated bond between carbon atoms) and a chain carbonate having no C═C unsaturated bond.

It is preferable that for the cyclic carbonate having no C═C unsaturated bond, at least one selected from the group consisting of ethylene carbonate, propylene carbonate and butylene carbonate is used.

It is preferable that for the chain carbonate having no C═C unsaturated bond, at least one selected from the group consisting of dimethyl carbonate, diethyl carbonate and ethyl methyl carbonate is used.

It is preferable that the non-aqueous electrolyte of the present invention comprises at least one selected from the group consisting of a cyclic carbonate having a C═C unsaturated bond and a dicarboxylic anhydride as an additive in an amount of 0.001 mass % to 10 mass %, more preferable that it comprises in an amount of 0.1 mass % to 5 mass %, and particularly preferable that it comprises in an amount of 0.5 masse to 3 mass %.

The present invention further relates to a non-aqueous electrolyte secondary battery comprising: a positive electrode including an active material comprising a lithium containing oxide; a negative electrode comprising an active material capable of absorbing and desorbing lithium; a separator interposed between the positive electrode and the negative electrode; and any one of the non-aqueous electrolytes as mentioned above.

### EFFECT OF THE INVENTION

A hydrogenated terphenyl included in a non-aqueous electrolyte oxidatively polymerizes during overcharge of a battery. As a result, the internal resistance of the battery is increased, and the battery is protected. The oxidative polymerization potential of the terphenyl is increased due to partial hydrogenation (adding hydrogen). This inhibits oxidative polymerization reaction in the battery during storage at high temperatures or during charge/discharge cycles. Accordingly, it is possible to ensure high-temperature storage characteristics or charge/discharge cycle characteristics, and safety during overcharge at the same time.

The high-temperature storage characteristics or the charge/discharge cycle characteristics and the safety during overcharge can be further improved by allowing diphenyl ether to be included in the non-aqueous electrolyte.

Further, an alkali salt containing boron has an effect of inhibiting oxidative polymerization of the hydrogenated terphenyl and diphenyl ether during storage at high temperatures or during charge/discharge cycles of the battery.

In view of the above, according to the present invention, it is possible to provide a non-aqueous electrolyte secondary battery excellent in high-temperature storage characteristics or charge/discharge cycle characteristics, and excellent in safety during overcharge.

### BRIEF DESCRIPTION OF THE DRAWINGS

FIG. 1 A partial cutaway perspective view of a rectangular lithium ion secondary battery according to an embodiment of the present invention.

### BEST MODE FOR CARRYING OUT THE INVENTION

A non-aqueous electrolyte of the present invention comprises a non-aqueous solvent, a solute dissolved in the non-aqueous solvent, and a hydrogenated terphenyl, the solute comprising an alkali salt containing boron and an alkali salt containing no boron.

The oxidizative polymerization potential of the hydrogenated terphenyl is high compared with that of a non-hydrogenated terphenyl. Accordingly, oxidative polymerization of the hydrogenated terphenyl is inhibited during storage at high temperatures or during charge/discharge cycles of the battery. In contrast, the hydrogenated terphenyl oxidatively polymerizes during overcharge of the battery.

The alkali salt containing boron has an effect of inhibiting the hydrogenated terphenyl and the diphenyl ether from oxidative polymerization during storage at high temperatures or during charge/discharge cycles of the battery.

The hydrogenated terphenyl may be a pure substance composed of a single compound, or a mixture composed of a plurality of compounds. For example, the hydrogenated terphenyl may be a mixture of two or more partial hydrides having different hydrogenation rates. Alternatively, the hydrogenated terphenyl may be a mixture of two or more structural isomers having a same hydrogenation rate, but being different in the position of the double bond at which hydrogenation has occurred.

Herein, the hydrogenation rate is a proportion of the amount of hydrogen that has been actually added with respect to the amount of hydrogen that is required for adding hydrogen to all the double bonds of terphenyl.

For the hydrogenated terphenyl, for example, the followings can be used:

(i) A mixture of a terphenyl that is not hydrogenated at all and a complete hydride of terphenyl;

(ii) A mixture of a terphenyl that is not hydrogenated at all and an incomplete hydride of terphenyl;

(iii) A mixture of an incomplete hydride of terphenyl and a complete hydride of terphenyl; and

(iv) A mixture of a terphenyl that is not hydrogenated at all, an incomplete hydride of terphenyl, and a complete hydride of terphenyl.

Herein, the incomplete hydride of terphenyl refers to a compound, in which hydrogen is added to a part of the double bonds of the benzene ring in o-terphenyl, m-terphenyl, or p-terphenyl.

The complete hydride of terphenyl is a compound, in which hydrogen is added to all the double bonds of the benzene ring in o-terphenyl, m-terphenyl, or p-terphenyl.

In the case where the hydrogenated terphenyl includes a terphenyl that is not hydrogenated at all, it is preferable that the proportion of the terphenyl that is not hydrogenated at all is not more than 10 mass % to the whole hydrogenated terphenyl.

The hydrogenation rate of the hydrogenated terphenyl is preferably in the range from 50% to 70% assuming that the hydrogenation rate of the terphenyl in which hydrogen is added to all the double bonds is 100%. Although the hydrogenation rate may be less than 50%, this reduces the effect of inhibiting the hydrogenated terphenyl from oxidative polymerization during storage at high temperatures and charge/discharge cycles of the battery. Although the hydrogenation rate may be more than 70%, this gradually reduces the effect of improving safety during overcharge.

It is preferable that an amount of the hydrogenated terphenyl contained in the non-aqueous electrolyte is 0.5 mass % to 3.5 mass %, more preferable that it is 1.0 mass % to 2.5 mass %, and particularly preferable that it is 1.0 mass % to 1.5 mass %. In the case where the content of the hydrogenated terphenyl is less than 0.5 mass %, the effect of ensuring safety during overcharge is reduced; and in the case of exceeding 3.5 mass %, the charge/discharge cycle characteristics may be degraded.

It is preferable that the non-aqueous electrolyte of the present invention further comprises diphenyl ether (DPE). The effect of improving safety during overcharge is small even when diphenyl ether is added singly to the non-aqueous electrolyte. However, in the case where diphenyl ether is added to the non-aqueous electrolyte together with the hydrogenated terphenyl and the alkali salt containing boron, a great effect can be obtained. In other words, the effect of improving safety during overcharge is increased and the cycle characteristics or the high-temperature storage characteristics of the battery are improved as well.

It is preferable that an amount of diphenyl ether (DPE) contained in the non-aqueous electrolyte is 0.1 mass % to 1 mass %, and particularly preferable that it is 0.2 mass % to 0.8 mass % (in other words, it is preferable that 0.1 mass % to 1 mass % of the whole non-aqueous electrolyte is diphenyl ether, and particularly preferable that 0.2 mass % to 0.8 mass % is diphenyl ether). In the case where the content of diphenyl ether is less than 0.1 mass %, the effect of further improving safety of the battery and the like is hardly obtained. In the case where the content of diphenyl ether exceeds 1 mass %, the capacity recovery rate of the battery during storage at high temperatures may be reduced.

Although the non-aqueous electrolyte is not necessarily limited, there may be used, for example, a cyclic carbonate having no C═C unsaturated bond, a chain carbonate having no C═C unsaturated bond, a cyclic carboxylic acid ester, a chain carboxylic acid ester, ethers (excluding DPE), nitrites, amides and the like.

The cyclic carbonate having no C═C unsaturated bond is exemplified by ethylene carbonate (EC), propylene carbonate (PC), butylene carbonate (BC) and the like. As the cyclic carbonate having no C═C unsaturated bond, in view of a dissociation property of the solute, it is preferable to use at least one selected from the group consisting of ethylene carbonate and butylene carbonate.

In view of decreasing the viscosity of the non-aqueous electrolyte, the chain carbonate having no C═C unsaturated bond is exemplified by dimethyl carbonate (DMC), diethyl carbonate (DEC), ethylmethyl carbonate (EMC) and the like. As the chain carbonate having no C═C unsaturated bond, it is preferable to use at least one selected from the group consisting of dimethyl carbonate, diethyl carbonate and methylethyl carbonate.

The cyclic carboxylic acid ester is exemplified by lactones such as γ-butyrolactone and γ-valerolactone.

The chain carboxylic acid ester is exemplified by methyl propionate, methyl pivalate and octyl pivalate, and the like.

The ethers include, for example, tetrahydrofuran; 2-methyl tetrahydrofuran; 1,4-dioxan; 1,2-dimethoxyethane; 1,2-diethoxyethane; 1,2-dibutoxyethane; and the like.

The nitrites include acetonitrile and the like, and the amides include dimethylformamide and the like.

The non-aqueous solvent may be used singly or in combination of arbitrary two or more. However, it is preferable that the non-aqueous solvent contains both a cyclic carbonate having no C═C unsaturated bond and a chain carbonate having no C═C unsaturated bond. The content of the cyclic carbonate having no C═C unsaturated bond with respect to the total of the cyclic carbonate having no C═C unsaturated bond and the chain carbonate having no C═C unsaturated bond is preferably in the range from 15 to 35 weight %, and more preferably in the range from 20 to 30 weight %. Moreover, it is preferable that the total of the cyclic carbonate having no C═C unsaturated bond and the chain carbonate having no C═C unsaturated bond is not less than 80 weight % of the whole non-aqueous solvent, and more preferable that it is not less than 90 weight %.

The non-aqueous electrolyte of the present invention may further contain various additives in addition to diphenyl ether (DPE). For example, it is preferable that the non-aqueous electrolyte contains at least one selected from the group consisting of a cyclic carbonates having a C═C unsaturated bond and a dicarboxylic anhydride as the additive. The cyclic carbonates having a C═C unsaturated bond and dicarboxylic acid anhydrides have an effect of improving the cycle characteristics and the charge/discharge efficiency. As the additive, the cyclic carbonate having a C═C unsaturated bond is particularly suitable.

Usable as the cyclic carbonate having a C═C unsaturated bond are, for example, vinylene carbonate (VC), vinylethylene carbonate (VEC), phenylethylene carbonate (PEC) and the like. Usable as the dicarboxylic acid anhydride are succinic acid anhydride, maleic acid anhydride and the like. In particular, by allowing vinylene carbonate (VC) to be contained in the non-aqueous electrolyte of the present invention together with diphenyl ether (DPE), the cycle characteristics and the high-temperature storage characteristics are improved significantly. It is conceivable that this relates to the fact that the non-aqueous electrolyte of the present invention includes the alkali salt containing boron.

As the additive, in addition to those mentioned above, in view of improving storage characteristics, there may be used ester sulfite such as ethylene sulfite, diethyl sulfite, propylene sulfite, dipropyl sulfite and dimethyl sulfite; sulfonic acid ester such as propanesultone, butanesultone, methyl methanesulfonate and methyl toluenesulfonate; sulfuric acid ester such as dimethyl sulfate, ethylene sulfate and diethyl sulfate; sulfone such as sulfolane, dimethyl sulfone and diethyl sulfone; sulfoxide such as dimethyl sulfoxide, diethyl sulfoxide and tetramethylene sulfoxide; sulfide such as diphenyl sulfide and thioanisole; disulfide such as diphenyl disulfide and dipyridinium disulfide; and the like. Further, in view of improving the low-temperature characteristics, a fluorine-containing aryl compound such as fluorobenzene may be used as the additive.

The additive may be used singly or in combination of two or more. It is preferable that an amount of the additive contained in the non-aqueous electrolyte is 0.001 mass % to 10 mass %, more preferable that it is 0.1 mass % to 5 mass %, and particularly preferable that it is 0.5 mass % to 3 mass % (in other words, it is preferable that 0.001 mass % to 10 mass % of the whole non-aqueous electrolyte is the additive, more preferable that 0.1 mass % to 5 mass % is the additive, and particularly preferable that 0.5 mass % to 3 mass % is the additive).

In the non-aqueous solvent, an alkali salt containing boron and an alkali salt containing no boron are dissolved as a solute. The alkali salt containing boron inhibits the hydrogenated terphenyl and the diphenyl ether from oxidative polymerization during storage at high temperatures or during charge/discharge cycles. On the other hand, the alkali salt containing no boron plays a role of sufficiently ensuring ion conductivity of the non-aqueous electrolyte.

The alkali salt containing boron is exemplified by LiBF₄, NaBF₄ and KBF₄ and the like. These may be used singly or in combination of two or more.

It is preferable that an amount of the alkali salt containing boron contained in the non-aqueous electrolyte is 0.1 mass % to 0.5 mass %, and more preferable that it is 0.15 mass % to 0.35 mass %. In the case where the content of the alkali salt containing boron is less than 0.1 mass %, the effect of improving the storage characteristics and the like may not be sufficiently obtained; and in the case of exceeding 0.5 mass %, the cycle characteristics may be degraded.

It is preferable that as the alkali salt containing no boron, a lithium salt having an anion that has an excellent electron withdrawing property is used. For example, LiPF₆, LiClO₄, LiAsF₆, LiCF₃SO₃, LiN(SO₂CF₃)₂, LiN(SO₂C₂F₅)₂, LiC(SO₂CF₃)₃ and the like may be used. These may be used singly or in combination of two or more.

The concentration of the alkali salt containing no boron contained in the non-aqueous electrolyte is preferably 0.5 M to 3 M (mol/liter), and more preferably 0.5 M to 1.5 M.

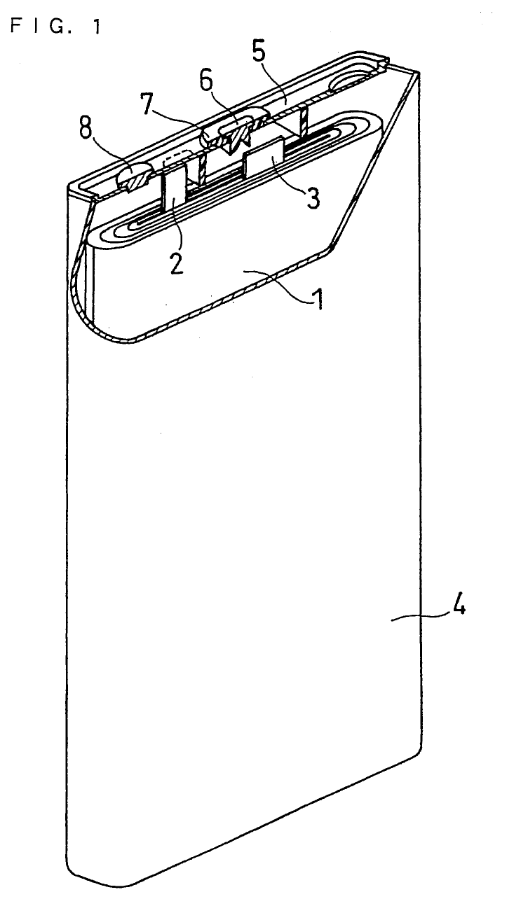

Next, an embodiment of a non-aqueous electrolyte secondary battery of the present invention will be described with reference to the drawing. FIG. 1 is a longitudinal cross section of an example of a rectangular lithium secondary battery.

A positive electrode plate and a negative electrode plate are wound with a separator interposed therebetween, to constitute an electrode assembly 1. The electrode assembly 1 is housed in a battery case 4 of a bottomed rectangular cylindrical shape. The negative electrode plate is connected with one end of a negative electrode lead 3. The other end of the negative electrode lead 3 is connected with a rivet 6 disposed in the center of a sealing plate 5 via an upper insulating plate (not shown). The rivet 6 is insulated from the sealing plate 5 by a sealing gasket 7. The positive electrode plate is connected with one end of a positive electrode lead 2. The other end of the positive electrode lead 2 is connected with the back face of the sealing plate 5 via the upper insulating plate. The lower end portion of the electrode assembly 1 and the battery case 4 are insulated by a lower insulating plate (not shown). The upper insulating plate provides insulation between the negative electrode lead 3 and the battery case 4, and between the electrode assembly 1 and the sealing plate 5.

The periphery of the sealing plate 5 is fit into the opening end portion of the battery case 4, and the fitting portion is sealed by means of laser welding. An injection aperture for non-aqueous electrolyte disposed in the sealing plate 5 is closed with a sealing cap 8, and sealed by means of laser welding.

The positive electrode plate is fabricated, for example, by applying a positive electrode material mixture paste on one face or both faces of a positive electrode current collector, and then drying and pressing to form a positive electrode active material layer. The positive electrode current collector is provided with a plain portion that carries no positive electrode active material layer, and the positive electrode lead is welded to the plain portion.

As the positive electrode current corrector, a metal foil, a metal sheet having undergone lath processing or etching treatment, or the like is used. As a material for the positive electrode current corrector, aluminum or an aluminum alloy is preferably used. A thickness of the positive electrode current corrector is, for example, 10 μm to 60 μm.

The positive electrode material mixture paste is prepared by mixing a positive electrode material mixture with a liquid dispersion medium. The positive electrode material mixture contains a positive electrode active material as an essential component, and contains a binder, a conductive agent, a thickener and the like as an arbitrary component.

As the positive electrode active material, for example, a lithium containing oxide capable of accepting lithium ions as a guest is used, although it is not necessarily limited thereto. For example, a composite metal oxide of: at least one transition metal selected from cobalt, manganese, nickel, chromium, iron and vanadium; and lithium is used.

Preferable among the composite metal oxides are LiₓCoO₂, LiₓMnO₂, LiₓNiO₂, LiₓCrO₂, αLiₓFeO₂, LiₓVO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄ (where M is at least one selected from the group consisting of Na, Mg, Sc, Y, Mn, Fe, Co, Ni, Cu, Zn, Al, Cr, Pb and B, x=0 to 1.2, y=0 to 0.9, z=2.0 to 2.3), a chalcogenide of a transition metal, a lithide of a vanadium oxide, a lithide of a niobium oxide, and the like. These may be used singly or in combination of two or more. Herein, the above-mentioned x value is increased or decreased by charge/discharge. It is preferable that a mean particle size of the positive electrode active material is 1 μm to 30 μm.

The negative electrode plate is fabricated, for example, by applying a negative electrode material mixture paste on one face or both faces of a negative electrode current collector, and then drying and pressing to form a negative electrode active material layer. The negative electrode current collector is provided with a plain portion that carries no negative electrode active material layer, and the negative electrode lead is welded to the plain portion.

As the negative electrode current corrector, a metal foil, a metal sheet having been subjected to lath processing or etching treatment, or the like is used. As a material for the negative electrode current corrector, cupper or a cupper alloy is preferably used. A thickness of the negative electrode current corrector is, for example, 10 μm to 50 μm.

The negative electrode material mixture paste is prepared by mixing a negative electrode material mixture with a liquid dispersion medium. The negative electrode material mixture contains a negative electrode active material as an essential component, and contains a binder, a conductive agent, a thickener and the like as an arbitrary component.

As the negative electrode active material, for example, a carbon material, a metal, an alloy, a metal oxide, a metal nitride and a metal oxynitride, or the like is used, although it is not necessarily limited thereto. These may be used singly or in combination of two or more.

As the carbon material, a material capable of desorbing and absorbing lithium ions by charge and discharge is used. For example, there may be used a sintered body of an organic polymer compound (phenol resin, polyacrylonitrile, cellulose, etc.), a sintered body of coke or pitch, artificial graphite, natural graphite, a graphitizable carbon material, a non-graphitizable carbon material, a pitch based carbon fiber, a PAN based carbon fiber, and the like. A shape of the carbon material is not necessarily limited, and for example, a material of a fibrous shape, a spherical shape, a scale shape, or a massive shape may be used.

For the metal and the alloy, for example, a silicon simple substance, a silicon alloy, a tin simple substance, a tin alloy, a germanium simple substance, a germanium alloy or the like may be used. Among these, the silicon simple substance and the silicon alloy are particularly preferable. It is preferable that a metal element other than silicon contained in the silicon alloy is a metal element that does not form an alloy with lithium. Although the metal element that does not form an alloy with lithium may be a chemically stable electron conductor, for example, titanium, copper, nickel and the like are preferable. One of these may be contained in the silicon alloy singly, or alternatively, a plurality of these may be contained in the silicon alloy at the same time.

In the case where the silicon alloy contains Ti, the molar ratio of Ti/Si is preferably O<Ti/Si<2, and particularly preferable 0.1≦Ti/Si≦1.0. In the case where the silicon alloy contains Cu, the molar ratio of Cu/Si is preferably O<Cu/Si<4, and particularly preferable 0.1≦Cu/Si≦2.0. In the case where the silicon alloy contains Ni, the molar ratio of Ni/Si is preferably O<Ni/Si<2, and particularly preferable 0.1≦Ni/Si≦1.0.

For the metal oxide, for example, a silicon oxide, a tin oxide, a germanium oxide or the like may be used. Among these, the silicon oxide is particularly preferable. It is preferable that the silicon oxide has a composition expressed by a general formula SiOx (where 0<x<2). Herein, it is further preferable that the value x representing the content of oxygen element is 0.01≦x≦1.

For the metal nitride, for example, a silicon nitride, a tin nitride, a germanium nitride or the like may be used. Among these, the silicon nitride is particularly preferable. It is preferable that the silicon nitride has a composition expressed by a general formula SiNy (where 0<y< 4/3). Herein, it is further preferable that the value y representing the content of nitride element is 0.01≦x≦1.

For the binder, the conductive agent, the thickener and the like that may be contained in the positive electrode material mixture or the negative electrode material mixture, analogues to the conventional ones may be used.

The binder is not necessarily limited as long as it is soluble or dispersible to a dispersion medium of the paste. For example, there may be used a fluorocarbon resin, acrylic rubber, a modified acrylic rubber, styrene-butadiene rubber (SBR), an acryl based polymer, a vinyl based polymer and the like. These may be used singly or in combination of two or more.

As the fluorocarbon resin, for example, polyvinylindene fluoride, copolymer of vinylidene fluoride and hexafluoropropylene, polytetrafluoroethylene or the like is preferable. These may be used, for example, as dispersion.

As the conductive agent, acetylene black, graphite, carbon fiber or the like may be used. These may be used singly or in combination of two or more.

As the thickener, ethylene-vinylalcohol copolymer, carboxymethylcellulose, methylcellulose or the like is preferable.

For the dispersion medium to be mixed with the positive electrode material mixture or the negative electrode material mixture, it is preferable to use a dispersion medium to which the binder is soluble or dispersible is used. In the case where a binder soluble or dispersible to an organic solvent is used, it is preferable that N-methyl-2-pyrrolidone; N,N-dimethylformamide; tetrahydrofuran; dimethylacetamide; dimethylsulfoxide; hexa-methylsulphonamide; tetramethylurea; acetone; methyl ethyl ketone; or the like is used singly or in combination. In the case where a binder soluble or dispersible to water is used, water or hot water is preferable.

The method for preparing the positive electrode material mixture paste or the negative electrode material mixture paste by mixing the positive electrode material mixture or the negative electrode material mixture with the dispersion medium is not necessarily limited. For example, a planetary mixer, a homomixer, a pin mixer, a kneader, a homogenizer or the like may be used. These may be used singly or in combination of two or more. Further, when kneading into a paste, various dispersants, surfactants, stabilizers and the like may be added as required.

The positive electrode material mixture paste or the negative electrode material mixture paste can be easily applied to the current corrector using, for example, a slit die coater, a reverse roll coater, a lip coater, a blade coater, a knife coater, a gravure coater, a dip coater or the like. It is preferable that the paste applied to the current collector is subjected to drying similar to natural drying. However, in view of productivity, it is preferable that the drying is carried out at a temperature from 70° C. to 200° C. for 10 minutes to 5 hours.

Pressing is carried out several times with a roll press machine at a line pressure of 1000 to 2000 kg/cm until the electrode plate has a predetermined thickness, for example, of 130 μm to 200 μm. It is preferable that pressing is carried out a plurality of times with varied line pressures.

As the separator, a microporous film composed of polymer is preferably used. As the polymer, polyethylene, polypropylene, polyvinylidene fluoride, polyvinylidene chloride, polyacrylonitrile, polyacrylamide, polytetrafluoroethylene, polysulfone, polyether sulfone, polycarbonate, polyamide, polyimide, polyether (polyethylene oxide or polypropylene oxide), cellulose (carboxymethyl cellulose or hydroxypropyl cellulose), poly (meta) acrylic acid, a poly (meta) acrylic ester, or the like is used.

The microporous film may be a multi-layered film composed of a plurality of layers. In particular, a microporous film formed of polyethylene, polypropylene, polyvinylidene fluoride and the like is preferable. A thickness of the separator is preferably, for example, from 10 μm to 30 μm.

Although the present invention is hereinafter described in detail with reference to Examples and Comparative Examples, it is to be noted that the present invention is not limited thereto.

### EXAMPLE 1

(i) Fabrication of a Positive Electrode Plate

LiCoO₂ (mean particle size 10 μm) serving as a positive electrode active material, carbon black serving as a conductive agent, and polyvinylidene fluoride (PVdF) serving as a binder were blended at a mass ratio of 100:3:4, then kneaded with an appropriate amount of N-methyl-2-pyrrolidone (NMP) to give a positive electrode material mixture paste.

The positive electrode material mixture paste was applied on both faces of a positive electrode current collector formed of an aluminum foil having a thickness of 30 μm by means of a doctor blade method so that a thickness after drying became approximately 230 μm. Then the current collector with paste was pressed so that a dry coating membrane had a thickness of 180 μm, and was cut into a predetermined size to obtain a positive electrode plate. To the positive electrode plate, a positive electrode lead made of aluminum was welded.

(ii) Fabrication of a Negative Electrode Plate

A carbon material (graphite) (mean particle size 25 μm) serving as an active material and styrene butadiene rubber serving as a binder was blended at a mass ratio of 100:5, then kneaded with an appropriate amount of water to give a negative electrode material mixture paste.

The negative electrode material mixture paste was applied on both faces of a negative electrode current collector formed of a cupper foil having a thickness of 20 μm by means of a doctor blade method so that a thickness after drying became approximately 230 μm. Then the current collector with paste was pressed so that a dry coating layer had a thickness of 180 μm, and was cut into a predetermined size to give a negative electrode plate. A negative electrode lead made of nickel was welded to the negative electrode plate.

(iii) Fabrication of an Electrode Assembly

The positive electrode plate and the negative electrode plate as fabricated above were wound with a separator formed of a microporous film made of polyethylene having a thickness of 25 μm interposed therebetween so that the cross section thereof was of an oblong shape, whereby an electrode assembly was obtained. The electrode assembly thus obtained was pressed from the long sides at a pressure of 0.4 MPa for 1.5 seconds to make it a flat shape.

(iv) Preparation of a Non-Aqueous Electrolyte

As a non-aqueous solvent, a mixture solvent that comprises ethylene carbonate (EC) serving as a cyclic carbonate having no C═C unsaturated bond and diethyl carbonate (DEC) serving as a chain carbonate having no C═C unsaturated bond at a molar ratio of 1:3 was used.

Into the mixture solvent, LiBF₄ was dissolved as an alkali salt containing boron, and LiPF₆ was further dissolved as an alkali salt containing no boron.

Subsequently, to the mixture solvent with alkali salts dissolved therein, a hydrogenated terphenyl was further added. Herein, hydrogenated m-terphenyl comprising the following components was used. Herein, the composition of the hydrogenated m-terphenyl was analyzed by gas chromatography.

| | |
|---|---|
| Completely hydrogenated m-terphenyl | 0.1 mass % |
| 1,3-dicyclohexylbenzene | 13.3 mass % |
| 3-phenyl bicyclohexyl | 16.2 mass % |
| 1,3-diphenyl cyclohexane | 23.1 mass % |
| m-cyclohexyl biphenyl | 43.6 mass % |
| m-terphenyl | 3.7 mass % |

In the non-aqueous electrolyte, the content of LiBF₄ was 0.5 mass % and the concentration of LiPF₆ was 1.0 M (mol/L), and the content of the hydrogenated m-terphenyl was 2.5 mass %.

(v) Fabrication of a Battery

A rectangular lithium ion secondary battery as illustrated in FIG. 1 was fabricated using the obtained electrode assembly.

First, the electrode assembly in a state in which a lower insulating plate was disposed in the lower end part was housed in a rectangular battery case formed of an aluminum alloy of alloy No. 3000 series. The aluminum alloy had a thickness of 0.4 mm and contained a small amount of manganese and copper.

A negative electrode lead extended from the electrode assembly was connected with a rivet disposed in the center of a sealing plate via an upper insulating plate. A positive electrode lead extended from the electrode assembly was connected with the back face of the sealing plate via the upper insulating plate.

Subsequently, the periphery of the sealing plate was fitted with the opening end of the battery case. The fitting portion was sealed by means of laser welding. Herein, the sealing plate is provided with a safety valve and an injection aperture.

Next, 2.14 g of a predetermined non-aqueous electrolyte was injected from the injection aperture. This is followed by closing the injection aperture with a sealing cap and sealing by means of laser welding.

A rectangular lithium ion secondary battery having a width of 34 mm, a thickness of 6 mm, a total height of 50 mm and a battery capacity of 850 mAh was thus fabricated.

The battery thus obtained was charged at a constant current of 170 mA until the battery voltage reached 4.2 V, and then discharged until the battery voltage reached 3.0 V. The aforementioned charge/discharge was repeated three times. Subsequently, the battery was further charged for 20 minutes at a constant current of 170 mA.

### EXAMPLE 2

A rectangular lithium ion secondary battery was fabricated in the same manner as in Example 1 except that the content of the hydrogenated m-terphenyl in the non-aqueous electrolyte was changed to 0.2 mass %.

### EXAMPLE 3

A rectangular lithium ion secondary battery was fabricated in the same manner as in Example 1 except that the content of the hydrogenated m-terphenyl in the non-aqueous electrolyte was changed to 0.5 mass %.

### EXAMPLE 4

A rectangular lithium ion secondary battery was fabricated in the same manner as in Example 1 except that the content of the hydrogenated m-terphenyl in the non-aqueous electrolyte was changed to 3.5 mass %.

### EXAMPLE 5

A rectangular lithium ion secondary battery was fabricated in the same manner as in Example 3 except that diphenyl ether was further contained in the non-aqueous electrolyte in an amount of 0.05 mass %.

### EXAMPLE 6

A rectangular lithium ion secondary battery was fabricated in the same manner as in Example 5 except that the content of the diphenyl ether in the non-aqueous electrolyte was changed to 0.1 mass %.

### EXAMPLE 7

A rectangular lithium ion secondary battery was fabricated in the same manner as in Example 5 except that the content of the diphenyl ether in the non-aqueous electrolyte was changed to 1.0 mass %.

### EXAMPLE 8

A rectangular lithium ion secondary battery was fabricated in the same manner as in Example 1 except that the content of the LiBF₄ in the non-aqueous electrolyte was changed to 0.1 mass %.

### EXAMPLE 9

A rectangular lithium ion secondary battery was fabricated in the same manner as in Example 1 except that the content of the LiBF₄ in the non-aqueous electrolyte was changed to 0.7 mass %.

### EXAMPLE 10

A rectangular lithium ion secondary battery was fabricated in the same manner as in Example 6 except that the content of the LiBF₄ in the non-aqueous electrolyte was changed to 0.15 mass %.

### EXAMPLE 11

A rectangular lithium ion secondary battery was fabricated in the same manner as in Example 6 except that the content of the LiBF₄ in the non-aqueous electrolyte was changed to 0.3 mass %.

### EXAMPLE 12

A rectangular lithium ion secondary battery was fabricated in the same manner as in Example 6 except that the content of the LiBF₄ in the non-aqueous electrolyte was changed to 0.35 mass %.

### EXAMPLE 13

A rectangular lithium ion secondary battery was fabricated in the same manner as in Example 11 except that the content of the hydrogenated m-terphenyl in the non-aqueous electrolyte was changed to 1.0 mass % and the content of the diphenyl ether was changed to 0.5 mass %.

### EXAMPLE 14

A rectangular lithium ion secondary battery was fabricated in the same manner as in Example 13 except that vinylene carbonate was further contained in the non-aqueous electrolyte in an amount of 2 mass %.

### EXAMPLE 15

A rectangular lithium ion secondary battery was fabricated in the same manner as in Example 13 except that vinylene carbonate and vinylethylene carbonate (VEC) were further contained in the non-aqueous electrolyte in an amount of 2 mass % and 1 mass %, respectively.

### EXAMPLE 16

A rectangular lithium ion secondary battery was fabricated in the same manner as in Example 1 except that vinylene carbonate was further contained in the non-aqueous electrolyte in an amount of 2 mass %.

### COMPARISON EXAMPLE 1

A rectangular lithium ion secondary battery was fabricated in the same manner as in Example 1 except that LiBF₄, which is an alkali salt containing boron, was not contained in the non-aqueous electrolyte.

### COMPARISON EXAMPLE 2

A rectangular lithium ion secondary battery was fabricated in the same manner as in Example 1 except that hydrogenated m-terphenyl was not contained in the non-aqueous electrolyte.

### COMPARISON EXAMPLE 3

A rectangular lithium ion secondary battery was fabricated in the same manner as in Example 1 except that hydrogenated m-terphenyl and LiBF₄ were not contained in the non-aqueous electrolyte.

### COMPARISON EXAMPLE 4

A rectangular lithium ion secondary battery was fabricated in the same manner as in Example 1 except that LiPF₆, which is an alkali salt containing no boron, was not contained but LiBF₄, which is an alkali salt containing boron, was contained in the non-aqueous electrolyte in an amount of 1.0 M.

### COMPARISON EXAMPLE 5

A rectangular lithium ion secondary battery was fabricated in the same manner as in Example 7 except that hydrogenated m-terphenyl was not contained in the non-aqueous electrolyte.

### COMPARATIVE EXAMPLE 6

A rectangular lithium ion secondary battery was fabricated in the same manner as in Comparative Example 5 except that the content of the diphenyl ether in the non-aqueous electrolyte was changed to 1.5 mass %.

### COMPARATIVE EXAMPLE 7

A rectangular lithium ion secondary battery was fabricated in the same manner as in Comparative Example 1 except that vinylene carbonate was further contained in the non-aqueous electrolyte in an amount of 2 mass %.

[Evaluation]

With respect to the batteries of Example 1 to Example 16 and Comparative Example 1 to Comparative Example 7, cells were fabricated, with which a charge/discharge cycle characteristic test, a high temperature storage characteristic test and an overcharge test were carried out. The results are show in Table 1. The test conditions are hereinafter described.

(Charge/Discharge Cycle Characteristics)

A charge/discharge cycle comprising the below-mentioned operations (a) to (d) was repeated.

(a) The batteries were charged under an environment of 20° C. at a constant current of 850 mA (1.0 ItA, one hour rate) until the battery voltages reached 4.2 V.

(b) The batteries were then charged at a constant voltage of 4.2 V until the current values reduced to 42.5 mA (0.05 ItA, 20 hour rate).

(c) Subsequently, the batteries were left to stand for 10 minutes.

(d) Next, the batteries were discharged at a constant current of 850 mA (1.0 ItA, one hour rate) until the battery voltages reached 3.0 V.

The battery capacities after one cycle and 500 cycles were measured. The proportion of the battery capacity after 500 cycles with respect to the battery capacity after one cycle was calculated as a percentage. A mean value of the batteries was obtained.

(High Temperature Storage Characteristics)

First, the batteries before storage at high temperatures were subjected to the above-mentioned operations (a) to (d) to determine the battery capacities before storage.

Next, the batteries were charged at a constant current of 850 mA (1.0 ItA, one hour rate) until the battery voltages reached 4.2 V.

The batteries were then charged at a constant voltage of 4.2 V until the current values reduced to 42.5 mA (0.05 ItA, 20 hour rate) to obtain a fully charged state.

The batteries in a fully charged state were stored under an ambient of 85° C. for 3 days.

The batteries after storage were discharged under an environment of 20° C. at a constant current of 850 mA (1.0 ItA, one hour rate) until the battery voltages reached 3.0 V so that the remaining capacities were discharged.

Next, the batteries after storage were subjected to the above-mentioned operations (a) to (d) to determine the battery capacities after storage.

The proportion of the battery capacity after storage with respect to the battery capacity before storage was calculated as a percentage. A mean value of the 10 batteries was calculated, which was referred to as a capacity recovery rate.

(Overcharge Test)

After discharged under an environment of 20° C. at a constant current of 850 mA (1.0 ItA, one hour rate) until the battery voltages reached 3.0 V, the batteries were kept charged at a constant current of 850 mA (1.0 ItA, one hour rate). The charge was stopped when the battery surface temperatures reached 105° C. or 110° C. The batteries after the charge stopped were checked for occurrence of thermal runaway.

TABLE 1

| | | | | | | | | High | | |
|---|---|---|---|---|---|---|---|---|---|---|
| | | | | | | | Charge/ | temperature | | |
| | | | | | | | discharge | storage | Overcharge test | |
| | | | | | | | cycle | characteristics | 105° C. | 110° C. |
| | Composition of Electrolyte | | | | | | characteristics | Capacity | charge | charge |
| | Hydrogenated | Diphenyl | | | | | after 500 | recovery | thermal | thermal |
| | terphenyl | ether | LiPF₆ | LiBF₄ | VC | VEC | cycles | rate | runaway | runaway |
| | (mass %) | (mass %) | (M) | (mass %) | (mass %) | (mass %) | (%) | (%) | rate | rate |
| Ex. 1 | 2.5 | — | 1.0 | 0.5 | — | — | 82 | 82 | 0/10 | 1/10 |
| Ex. 2 | 0.2 | — | 1.0 | 0.5 | — | — | 84 | 83 | 1/10 | 3/10 |
| Ex. 3 | 0.5 | — | 1.0 | 0.5 | — | — | 83 | 83 | 0/10 | 2/10 |
| Ex. 4 | 3.5 | — | 1.0 | 0.5 | — | — | 81 | 81 | 0/10 | 0/10 |
| Ex. 5 | 0.5 | 0.05 | 1.0 | 0.5 | — | — | 84 | 84 | 0/10 | 2/10 |
| Ex. 6 | 0.5 | 0.1 | 1.0 | 0.5 | — | — | 84 | 84 | 0/10 | 0/10 |
| Ex. 7 | 0.5 | 1.0 | 1.0 | 0.5 | — | — | 82 | 80 | 0/10 | 0/10 |
| Ex. 8 | 2.5 | — | 1.0 | 0.1 | — | — | 81 | 82 | 0/10 | 1/10 |
| Ex. 9 | 2.5 | — | 1.0 | 0.7 | — | — | 82 | 76 | 0/10 | 1/10 |
| Ex. 10 | 0.5 | 0.1 | 1.0 | 0.15 | — | — | 86 | 85 | 0/10 | 0/10 |
| Ex. 11 | 0.5 | 0.1 | 1.0 | 0.3 | — | — | 89 | 83 | 0/10 | 0/10 |
| Ex. 12 | 0.5 | 0.1 | 1.0 | 0.35 | — | — | 91 | 84 | 0/10 | 0/10 |
| Ex. 13 | 1.0 | 0.5 | 1.0 | 0.3 | — | — | 89 | 84 | 0/10 | 0/10 |
| Ex. 14 | 1.0 | 0.5 | 1.0 | 0.3 | 2 | — | 93 | 89 | 0/10 | 0/10 |
| Ex. 15 | 1.0 | 0.5 | 1.0 | 0.3 | 2 | 1 | 93 | 91 | 0/10 | 0/10 |
| Ex. 16 | 2.5 | — | 1.0 | 0.5 | 2 | — | 85 | 86 | 0/10 | 1/10 |
| Com. Ex. 1 | 2.5 | — | 1.0 | — | — | — | 79 | 75 | 0/10 | 1/10 |
| Com. Ex. 2 | — | — | 1.0 | 0.5 | — | — | 83 | 83 | 6/10 | 10/10 |
| Com. Ex. 3 | — | — | 1.0 | — | — | — | 80 | 75 | 6/10 | 10/10 |
| Com. Ex. 4 | 2.5 | — | — | (1.0M) | — | — | 70 | 82 | 0/10 | 1/10 |
| Com. Ex. 5 | — | 1.0 | 1.0 | 0.5 | — | — | 81 | 81 | 1/10 | 5/10 |
| Com. Ex. 6 | — | 1.5 | 1.0 | 0.5 | — | — | 74 | 74 | 1/10 | 2/10 |
| Com. Ex. 7 | 2.5 | — | 1.0 | — | 2 | — | 81 | 77 | 0/10 | 1/10 |

From Examples and Comparative Examples in Table 1, it has been clarified that the battery including the non-aqueous electrolyte of the present invention is excellent in charge/discharge cycle characteristics and high temperature storage characteristics, and excellent in safety during overcharge as well. Conceivably, this is because the non-aqueous electrolyte of the present invention includes an alkali salt containing boron, an alkali salt containing no boron and a hydrogenated terphenyl.

From Examples 1 to 4 and Comparative Example 2, it is found that the content of the hydrogenated terphenyl is preferably 0.5 to 3.5 mass %. From Example 2, it is further found that a certain degree of effect of improving safety during overcharge can be obtained even when the content of the hydrogenated terphenyl is small.

From Example 3 and Examples 5 to 7, in view of improving safety during overcharge, it is found that the content of diphenyl ether in the non-aqueous electrolyte is preferably 0.1 mass % to 1 mass %. Although the effect is not clear when the content of the diphenyl ether is 0.05 mass %, the safety has been conceivably improved to some extent.

From Example 1, Examples 8 to 9 and Comparative Example 1, it is found that the content of the LiBF₄, which is an alkali salt containing boron, is preferably in the range from 0.1 mass % to 0.5 mass %. In Example 9, in which the content of the LiBF₄ is 0.7 mass %, although a tendency of decrease in the high temperature storage characteristics is observed, the other characteristics are favorable. Moreover, from Examples 10 to 13, it is found that the content of the LiBF₄, which is an alkali salt containing boron, is particularly preferably in the range from 0.15 mass % to 0.35 mass %.

From Examples 13 to 15 and Examples 1, 2 and 16, it is found that the charge/discharge cycle characteristics and the high temperature storage characteristics are significantly improved by allowing the non-aqueous electrolyte including the hydrogenated terphenyl and the alkali salt containing boron to further include vinylene carbonate (VC) or vinylethylene carbonate (VEC).

On the other hand, from Comparative Example 1 and Comparative Example 7, it is found that in the case of the non-aqueous electrolyte including the hydrogenated terphenyl but not including the alkali salt containing boron, the effect achieved by adding vinylene carbonate (VC) is suppressed at a low level.

From Comparative Example 4, it has been clarified that in the case where the non-aqueous electrolyte exclusively includes LiBF₄, which is an alkali salt containing boron, as a solute, sufficient charge/discharge cycle characteristics cannot be obtained.

### EXAMPLE 17

Metallic Ti (particle size 100 to 150 μm) and metallic Si (mean particle size 3 μm) were weighed so that the weight ratio of Ti:Si is 9.2:90.8 and mixed together. 3.5 kg of the obtained mixture powder was weighed and supplied to a vibration mill apparatus (FV-20 produced by CHUO KAKOHKI CO., LTD.). Balls (diameter 2 cm) made of stainless steel were further supplied to the mill apparatus so that the balls filled 70 volume % of the mill apparatus. After the interior of the container was drawn to vacuum, Ar (purity 99.999%, produced by NIPPON SANSO CORPORATION) was introduced therein to allow the interior of the mill apparatus to be at one atmosphere. With respect to the operating conditions of the mill apparatus, the amplitude was 8 mm and the rotation speed was 1200 rpm. Under these conditions, mechanical alloying was carried out for 80 hours.

The TiSi alloy obtained by the above-mentioned operations was collected and classified using a screen to give a TiSi alloy having a mean particle size of 5 μm. The TiSi alloy thus obtained was analyzed by X-ray diffractometry and a particle size of the crystal grain (crystallite) was calculated using the half-width of the peak. The mean particle size of the crystal grain was 10 nm. It was presumed from the X-ray diffraction image that an Si simple substance phase and a TiSi₂ phase were present in the TiSi alloy and the weight ratio of Si:TiSi₂ was 80:20.

The alloy obtained as mentioned above and graphite (mean particle size 25 μm) were mixed at a weight ratio of 50:50. To 100 parts by weight of the total of the alloy and the graphite, 5 parts by weight of polyacrylic acid (molecular weight 150,000, produced by Wako Pure Chemical Industries Ltd.) as a binder was added, and then sufficiently kneaded together with pure water to give a negative electrode material mixture paste. The resultant negative electrode material mixture paste was applied on both faces of a negative electrode current collector formed of an electrolytic cupper foil (produced by FURUKAWA CIRCUIT FOIL Co., Ltd.) having a thickness of 10 μm, and then dried. The foil with the paste was pressed and cut into a predetermined size, whereby a negative electrode plate was obtained.

A rectangular lithium ion secondary battery was fabricated in the same manner as in Example 14 except that the obtained negative electrode plate was used. This battery was evaluated in the same manner as mentioned above except that the number of times of charge/discharge cycle was changed to 100. As a result, the charge/discharge cycle characteristics (after 100 cycles) was 89%, the capacity recovery rate was 83%, the thermal runaway rates during the overcharge test at 105° C. and 110° C. were both 0/10 (i.e., 0%).

### EXAMPLE 18

100 parts by weight of silicon oxide (SiO)(mean particle size 10 μm, produced by KOJUNDO CHEMCIAL LABORATORY Co., Ltd.), 20 parts by weight of carbon black, 7 parts by weight of a binder of polyvinylidene fluoride, and an appropriate amount of N-methyl-2-pyrrolidone (NMP) were mixed to prepare a negative electrode material mixture paste. The negative electrode material mixture paste was applied on both faces of a cupper foil having a thickness of 15 μm, and then dried. The foil with the paste was pressed and cut into a predetermined size, whereby a negative electrode plate was obtained.

A rectangular lithium ion secondary battery was fabricated in the same manner as in Example 14 except that the negative electrode plate thus obtained was used. This battery was evaluated in the same manner as mentioned above except that the number of times of charge/discharge cycle was changed to 100. As a result, the charge/discharge cycle characteristics (after 100 cycles) was 88%, the capacity recovery rate was 83%, the thermal runaway rates during the overcharge test at 105° C. and 110° C. were both 0/10 (i.e., 0%).

From Example 17 and Example 18, it was confirmed that the present invention was effective regardless of the types of the negative electrode.

Further, batteries were fabricated in the same manner as in Example 1 using lithium nickel oxide (LiNiO₂), lithium manganese oxide (LiMn₂O₄), and various modified substances obtained by replacing a part of transition metals of these oxides with an other metal, as a positive electrode active material in place of LiCoO₂, and were evaluated similarly. As a result, it was confirmed that the present invention was effective regardless of the types of the positive electrode active material.

### INDUSTRIAL APPLICABILITY

The shape of a battery to which the non-aqueous electrolyte of the present invention is applicable is not necessarily limited and the battery may be of any shape, for example, a coin shape, a button shape, a sheet shape, a cylindrical shape, a flat shape, a rectangular shape and the like. The form of the electrode assembly comprising the positive electrode, the negative electrode and the separator is not limited either, and the present invention is applicable to either of a winding type or a stacking type. The size of the battery is not limited either, and the present invention is applicable to any battery of a small size, a medium size or a large size.

The present invention is particularly useful for a drive power source of equipment such as consumer electronics equipment, mobile information terminals, mobile electronics equipment, portable equipment and cordless equipment, the equipment being required to be highly reliable in charge/discharge cycle characteristics, high temperature characteristics, safety during overcharge, etc. Furthermore, the present invention is useful for a power source of domestic small power storage apparatuses, motorbikes, electric cars, hybrid electric cars and the like.

1. A non-aqueous electrolyte comprising
(a) a non-aqueous solvent;
(b) a solute dissolved in said non-aqueous solvent; and
(c) a hydrogenated terphenyl,
said solute (b) comprising an alkali salt containing boron and an alkali salt containing no boron.

2. The non-aqueous electrolyte in accordance with claim 1, wherein an amount of said hydrogenated terphenyl (c) contained in said non-aqueous electrolyte is 0.5 mass % to 3.5 mass %.

3. The non-aqueous electrolyte in accordance with claim 1, wherein an amount of said hydrogenated terphenyl (c) contained in said non-aqueous electrolyte is 1.0 mass % to 1.5 mass %.

4. The non-aqueous electrolyte in accordance with claim 1, wherein said alkali salt containing boron includes at least one selected from the group consisting of LiBF₄, NaBF₄ and KBF₄.

5. The non-aqueous electrolyte in accordance with claim 1, wherein an amount of said alkali salt containing boron contained in said non-aqueous electrolyte is 0.1 mass % to 0.5 mass %.

6. The non-aqueous electrolyte in accordance with claim 1, wherein an amount of said alkali salt containing boron contained in said non-aqueous electrolyte is 0.15 mass % to 0.35 mass %.

7. The non-aqueous electrolyte in accordance with claim 1, wherein said alkali salt containing no boron includes at least one selected from the group consisting of LiPF₆, LiClO₄, LiAsF₆, LiCF₃SO₃, LiN(SO₂CF₃)₂, LiN(SO₂C₂F₅)₂ and LiC(SO₂CF₃)₃.

8. The non-aqueous electrolyte in accordance with claim 1, further comprising diphenyl ether (DPE) in an amount of 0.1 mass % to 1 mass %.

9. The non-aqueous electrolyte in accordance with claim 1, wherein said non-aqueous solvent (a) includes a cyclic carbonate having no C═C unsaturated bond and a chain carbonate having no C═C unsaturated bond.

10. The non-aqueous electrolyte in accordance with claim 9, wherein said cyclic carbonate having no C═C unsaturated bond includes at least one selected from the group consisting of ethylene carbonate, propylene carbonate and butylene carbonate.

11. The non-aqueous electrolyte in accordance with claim 9, wherein said chain carbonate having no C═C unsaturated bond includes at least one selected from the group consisting of dimethyl carbonate, diethyl carbonate and ethyl methyl carbonate.

12. The non-aqueous electrolyte in accordance with claim 1, further comprising at least one selected from the group consisting of a cyclic carbonate having a C═C unsaturated bond and a dicarboxylic anhydride in an amount of 0.001 mass % to 10 mass %.

13. A non-aqueous electrolyte secondary battery comprising: a positive electrode including an active material comprising a lithium containing oxide, a negative electrode comprising an active material capable of absorbing and desorbing lithium, a separator interposed between said positive electrode and said negative electrode and the non-aqueous electrolyte in accordance with claim 1.
